(19) United States
(12) Patent Application Publication
(10) Pub. No.: US 2010/0275129 A1
(43) Pub. Date: Oct. 28, 2010

(54) Internet-based small-business promotional network

(76) Inventor: Barry Jay Besecker, Xenia, OH (US)

Correspondence Address: Paul E Schaafsma, NovusIP, LLC, 521 West Superior Street, Suite 221, Chicago, IL, 60654, US

(21) Appl. No.: 12/386,815

(22) Filed: Apr. 23, 2009

(51) Int. Cl. G06F 3/00

(52) U.S. Cl. 715/745

(57) ABSTRACT

In accordance with the principles of the resent invention, an Internet-based business promotional service that helps traditional “brick and mortar” small businesses link-up and promote one another through an online, automated service is provided. A user registers for the system. The user searches for businesses that are also members. The user invites members to join a user's unique businesses promotional network. The user creates a promotion. A promotional material is automatically generated based on the user's and any user's promotional network member's promotions. Which members of the user's promotional network who are sending a user customers is tracked.

### FIELD OF THE INVENTION

The present invention relates to the Internet.

### BACKGROUND OF THE INVENTION

The Internet is a global network of computers. Network servers support hypertext capabilities that permit the Internet to link together webs of documents. User interfaces such as Graphical User Interfaces (GUI) are typically used to navigate the Internet to retrieve relevant documents. Uniform Resource Locators (URLs) are used to identify specific web sites and web pages on the Internet. URLs also identify the address of the document to be retrieved from a network server. The Transfer Control Protocol/Internet Protocol (TCP/IP) is used to transfer information.

The Internet uses a hypertext language referred to as the hypertext mark-up language (HTML). HTML is a commonly used scripting or programming language that permits content providers or developers to place hyperlinks within web pages. These hyperlinks link related content or data, which may be found on multiple Internet host computers. HTML document links may retrieve remote data by use of HyperText Transfer Protocol (HTTP). Alternatively, File Transfer Protocol (FTP) for file transfer, the network news protocol (NNTP) for discussion groups, and the simple mail transport protocol (SMTP) for email or other Internet application protocols can be used. When a user selects a link in a web document, the link icon in the document contains the URL that the client employs to initiate the session with the server storing the linked document. HTTP is the protocol used to support the information transfer.

While most of today's users of the Internet believe it is a recent communications phenomenon, the origins of the Internet actually go back several decades. Today's Internet grew out a computer resource-sharing network created in the 1960s by the Advanced Research Projects Agency (ARPA). This computer resource-sharing network, which came to be known as the ARPAnet, was primarily designed by ARPA's chief scientist, Larry Roberts. The initial problem facing a wide-area computer resource-sharing network was how to efficiently transmit digitized information in a reliable way. To solve this problem, in 1968, Roberts mandated use of a packet-switching design in the ARPAnet.

Packet switching breaks up blocks of digitized information into smaller pieces called packets. These packets are transmitted through the network, usually by different routes, and are then reassembled at their destination. Eight years prior to ARPA's Request for Proposal, Len Kleinrock invented packet switching. See, e.g., Len Kleinrock, “Information Flow in Large Communications Nets,” RLE Quarterly Progress Report (1960); Len Kleinrock, Communication Nets (1964). See also Paul Baren, “On Distributed Communications Networks,” IEEE Transactions on Systems (March 1964). Roberts believed that packet switching was the means to efficiently transmit digitized information in a reliable way.

The next problem to solve was how to interconnect a number of mainframe computers, most of which utilized different languages and different operating systems. Wesley Clark of Washington University in St. Louis, Mo., devised the solution to this huge incompatibility problem. Clark proposed that a smaller microcomputer should interface between every mainframe and the network. All of these minicomputers would run on the same operating system and use the same language. Each mainframe, therefore, would only be required to interface with its own minicomputer, with the minicomputer translating into the network operating system and language. These Interface Message Processors (IMP), which provided an interface between the ARPAnet host mainframe computers and the ARPAnet, were the predecessors to today's routers. With this basic design, the first two nodes on the ARPAnet communicated on 1 Oct. 1969.

By 1971, 15 nodes, mostly academic institutions, were up on the ARPAnet; however, the original goal of the ARPAnet was not being realized. Resource sharing of the mainframe computers was simply too cumbersome. In March 1972, Ray Tomlinson of consulting firm Bolt, Beranek & Newman invented e-mail. Use of this message transfer program quickly grew to be the initial major use of the ARPAnet.

By the mid-seventies, the ARPAnet was not the only network utilizing switching packets. Once again, an incompatibility problem emerged. Each of these different networks used a different protocol. Thus, interconnection of these different networks was not possible. The solution, devised by Robert Kahn of ARPA and Vincent Cerf of Stanford University, was called the Transmission Control Protocol/Internet Protocol. The Transmission Control Protocol packetized information and reassembled the information upon arrival. The Internet Protocol routed packets by encasing the packets between networks. See, e.g., Robert Kahn and Vincent Cerf, “A Protocol for Packet Network Intercommunication,” IEEE Transactions on Communications Technology (May 1974). Transmission Control Protocol/Internet Protocol was adopted by the ARPAnet in 1983. With the addition of the Domain Name System (DNS) in November 1983, the now familiar Internet address protocol was established.

A final step in creating the Internet occurred in 1990, when an Englishman, Tim Berners-Lee working at the European Center for Particle Research (CERN) in Switzerland, invented the World Wide Web. This software, based on a program Berners-Lee had written in 1980 to allow users to store information using random associations, allowed material from any computer, from any format to be translated into a common language of words, images, and addresses. Berners-Lee's program established the three core components of the World Wide Web: the Universal Resource Locator, Hypertext Transfer Protocol, and HyperText Markup language.

Now, the World Wide Web has become a new mass media system for information distribution. With the help of advertising support, new media companies have created thousands of news, sports, entertainment, and special interest web sites. The initial focus of e-commerce technologies on the Internet was to facilitate business-to-consumer (B2C) transactions. This lead to a frenzy of investment into nearly any Internet related B2C idea, even where the idea lacked real merit. This investment frenzy came to an abrupt end when the Internet valuation bubble burst in March 2000: from its March 2000 high of 5,047.69, the technology rich NASDAQ stock index fell over 40%.

More recently, the Internet has seen the rise of social network web-sites. Social network web-sites focus on building online communities of people who share interests and/or activities, or who are interested in exploring the interests and activities of others. Most social network web-sites provide a variety of ways for users to interact, such as e-mail and instant messaging services. The main types of social networking services are those which contain category divisions (such as former school-year or classmates), means to connect with friends (usually with self-description pages), and a recommendation system linked to trust. Popular methods now combine many of these, with MySpace and Facebook being the most widely used in North America.

MySpace and Facebook were created at about the some time, approximately in 2003. MySpace (http://www.myspace.com) is a social networking website with an interactive, user-submitted network of friends, personal profiles, blogs, groups, photos, music, and videos for teenagers and adults internationally. In June 2006, MySpace was the most popular social networking site in the United States. According to comScore (11950 Democracy Drive, Suite 600, Reston, Va. 20190), MySpace was overtaken internationally by main competitor Facebook in April 2008, based on monthly unique visitors. The 100 millionth account was created on 6 Aug. 2006.

In Facebook (http://www.facebook.com), users can join networks organized by city, workplace, school, and region to connect and interact with other people. People can also add friends and send them messages, and update their personal profiles to notify friends about themselves. Myspace and Facebook are seen mainly as personal, non-business marketing and communication among friends to share personal preferences in music, people, and other social topics.

While Myspace and Facebook are primarily personal, professional network web-sites attempt to create a virtual community that it is focused on professional interactions instead of social interactions. Linked In (http://www.linkedin.com) is a business-oriented social networking site founded launched in May 2003 mainly used for professional networking. As of February 2009, it had more than 35 million registered users, spanning 170 industries. However, these professional networking sites are primarily targeted towards professionals and do not provide an opportunity for a network of small businesses to link-up and promote one another. What is thus needed is an Internet-based service that helps small businesses link-up and promote one another is provided.

### SUMMARY OF THE INVENTION

In accordance with the principles of the present invention, an Internet-based service that helps traditional “brick and mortar” small businesses link-up and promote one another through an online, automated service is provided. The user searches for businesses that are also members. The user invites members to join a user's unique promotional network. The user creates a promotion. A promotional material is automatically generated based on the user's and any user's promotional network member's promotions. Which members of the user's promotional network who are sending a user customers is tracked.

### BRIEF DESCRIPTION OF THE DRAWINGS

FIG. 1 is a schematic of a non-limiting example hardware architecture that can be used to run the system of the present invention.

FIG. 2 is an example of a homepage for the present invention.

FIG. 3 is an example of a creating a user profile page of the present invention.

FIG. 4 is an example of a user profile page of the present invention.

FIG. 5 is an example of an advanced partner search page of the present invention.

FIG. 6 is an example of an advanced partner search results page of the present invention.

FIG. 7 is an example of a user's network page of the present invention.

FIG. 8 is an example of a create promotions page of the present invention.

FIG. 9 is an example of an AdSheet of the present invention.

FIG. 10 is an example of logging redemptions results page of the present invention.

### DETAILED DESCRIPTION OF A PREFERRED EMBODIMENT

Every small business is trying to reach new customers. Advertising is expensive and results are almost impossible to measure. Many local businesses promote themselves by asking other local businesses to hand out flyers. In return, that local business would often hand out flyers for other businesses. Some businesses have become more sophisticated and have organized associations for the purpose of cross promotion with other businesses in a community. But such cross-promotion is labor and time intensive, and small business owners already cannot find enough hours in the day. In addition, such efforts employ no standardization, no means of tracking participation, etc.

In accordance with the principles of the present invention, an Internet-based service is provided that helps offline small businesses link-up and promote one another. By offline what is meant is a business that has at least a “brick and mortar” component to them, but does not exclude businesses that have web-sites. In addition, while the present invention is particularly suited for small businesses, it is by no means so limited. In accordance with the present invention, a user registers for the system and creates a profile for the user's business. The user can search for businesses in a user's area that are also members. The user can invite members that serve similar customers to join a user's promotional network. Such members are non-limitingly referred to herein as partners. The user can create a new promotion in a given time period, such as for example each month. As described in detail below, creating a new promotion takes as little as 30 seconds, with no graphic skills needed. In addition, the present invention standardizes promotion exchange, with promotions prepared on a given schedule.

A deliverable of the present invention is a promotional material non-limitingly referred to herein as an “AdSheet”. An AdSheet is a page that is automatically created each month by the system of the present invention. A user's promotion will appear on the page, at the top of the page in one example, and a user's partners' promotions will appear below, for example. The promotions on a user's AdSheet will include the unique ID of the user that printed the AdSheet—so that so when customers from a user's business visits another business, this ID will tell a user's partner which user sent them. Likewise, a user will be able to track which partners are sending customers to the user's store from the user's partners' AdSheet ID printed on the promotions that are redeemed in a user's business.

Copies of a user's AdSheet are printed and distributed to a user's customers in a user's business. A user's partners will be distributing a user's promotion, while the user will be distributing a user's own promotion plus the promotions of a user's partners. Which partners are sending a user customers can be tracked through their unique ID.

Participation in the system of the present invention is simple and requires only a few minutes of a user's time each month. Once registered, all a user needs to do is invite other members to join a user's promotional network, set up a monthly promotion, print a user's AdSheet, and distribute copies (with no graphic skills required). A user only needs to make copies of a user's AdSheet in a user's business. The power of the present invention can be seen with an example: imagine a user's promotion being distributed to all of the customers in the businesses of 16 partners. At an average of just 250 customers per business per month, a user reaches 4,000 new customers with the endorsement of a user's partners—every single month!

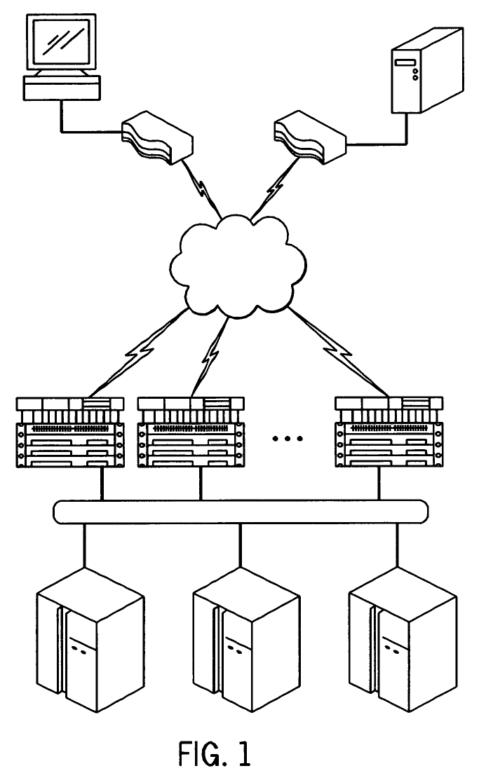

In more detail, a web-site implementation the present invention can be accessed using a web browser, integrated desktop application or any other means of receiving and rendering content from a web server. Referring to FIG. 1, a non-limiting example of a high level implementation that can be used to run a system of the present invention is seen. The infrastructure should include but is not limited to: wide-area network connectivity; network infrastructure; an operating system such as for example Redhat Linux Enterprise Linux AS Operating System available from Red Hat, Inc., 1801 Varsity Drive, Raleigh, N.C.; appropriate network switches and routers; electrical power (backup power); network backup hardware and software, and message software such as for example Tibco SmartSockets messaging software available from Tibco Software Inc., 3303 Hillview Avenue, Palo Alto, Calif.

The match engine (1) and administrative applications server (3) can run for example on an HP Proliant DL740 server with 4 3.0 GHz processors, 64 GB or RAM, 60 GIG Raid level 1 and 1 GHZ network connection, available from the Hewlett-Packard Company, 3000 Hanover Street, Palo Alto, Calif. The database server (2) can be run for example on an HP Proliant DL740 server with 4 3.0 GHz processors, 64 GB or RAM, 300 GIG Raid level 3 and two 1 GHZ network connections, and an active backup system, capable of backing up and restoring while the system is active. The order routing and management applications (5) can be run for example on HP Proliant DL360 server with 2 3.6 GHz processors, 8 GB or RAM, 60 GIG Raid level 1 and 1 GHZ network connection, also available from the Hewlett-Packard Company.

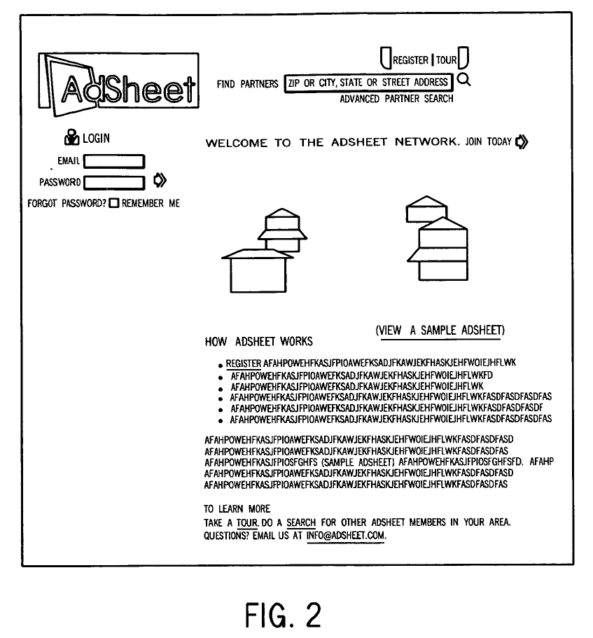

Referring to FIG. 2 an example homepage for a web-based service that helps small businesses link-up and promote one another of the present invention is seen. In addition to site information and marketing, the homepage can include a user login, a link to a registration page, and a link to a tour of the site. In addition, the homepage can include a link to a find partners subroutine, as described in more detail below.

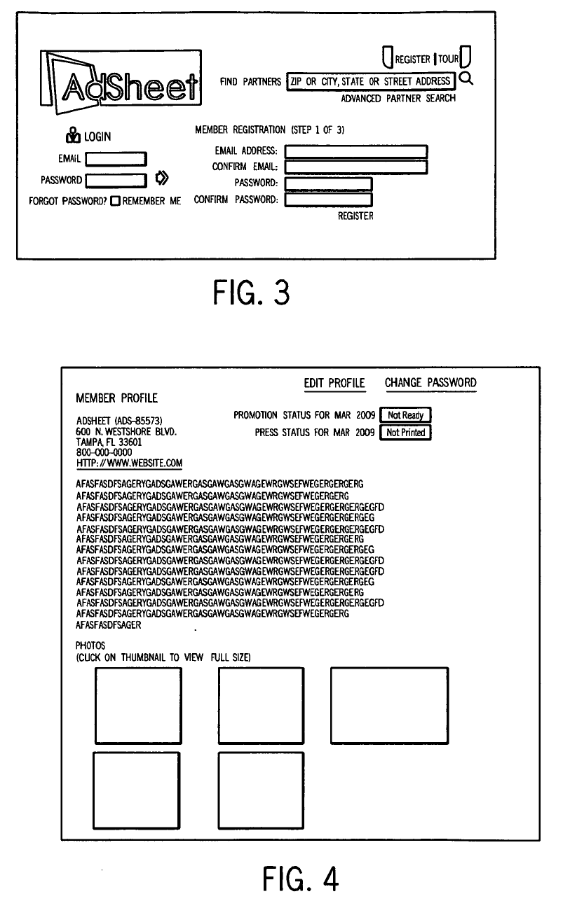

Referring to FIGS. 3 and 4, creating a user profile subroutine is described. Registration can be designed to take just a few minutes. The user can include the same information typically include in a telephone directory listing (e.g., business name, address, etc.). An example of a creating a user profile page is seen in FIG. 3. A user can also add a description of a user's business and upload photos to personalize a user's profile. To help other members decide whether to invite a user to join their promotional network, the types of customers a user serve, how a user will distribute the AdSheet, and other helpful information can be highlighted, an example of which is seen in FIG. 4.

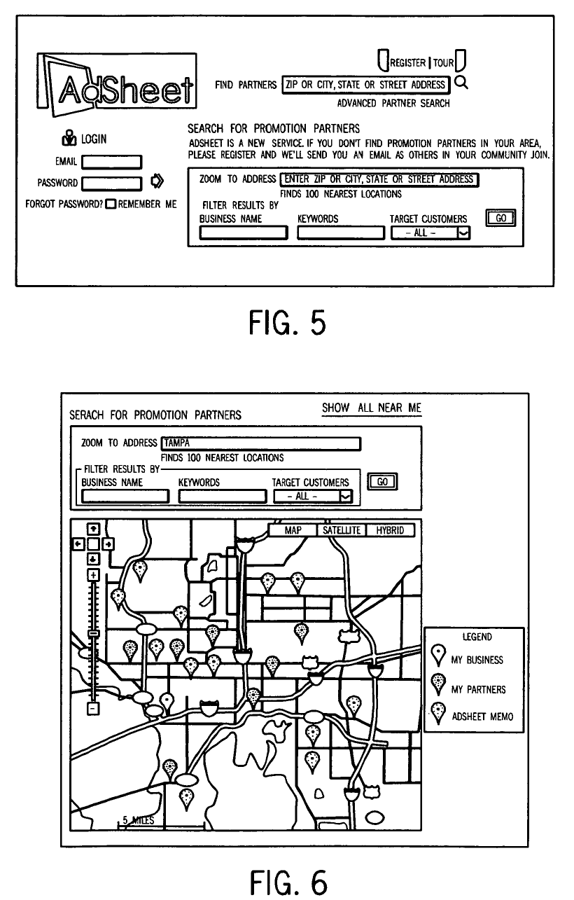

Referring to FIGS. 5 and 6, a finding partners subroutine is described. To find partners, a location near a user is entered (e.g., zip code, city & state, etc.). In one embodiment, an advanced partner search subroutine can be provided, which enables the user to filter the search results, such as for example by business name, keywords, target customers, etc. An example of an advanced partner search page is seen in FIG. 5. The potential partners will be shown in the results. In one example, the potential partners can be listed by geographic proximity. In one example the result can be displayed on a map, an example of which is seen in FIG. 6. A user's business will appear as highlighted, for example as a gold map pin; a user's partners in a different highlight, for example green map pins; and non-partners in a different highlight, for example red map pins. A user can filter a user's search results. For instance, if a user runs a business that appeals to women over 30, a user may wish to invite partners that also serve women over 30.

To view a partner and profile, the user simply clicks a map pin. To ask another member to join a user's promotional network, the user simply clicks on an “invite” link. A notice of an invite can be e-mailed to a user's registered email account.

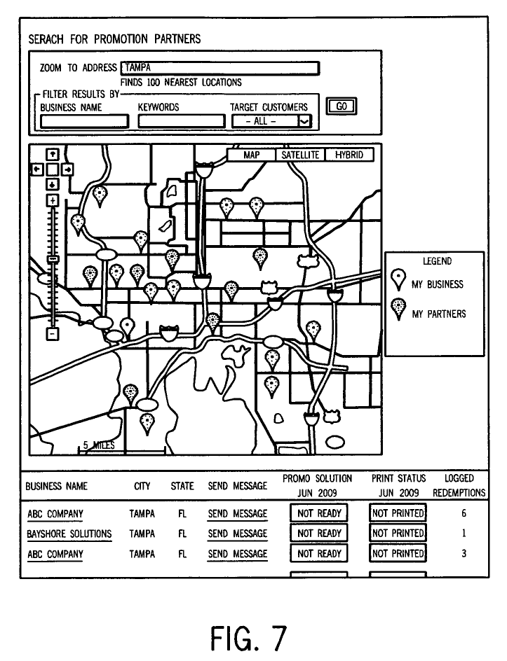

Referring to FIG. 7, viewing a user's promotional network subroutine is described. To view a user's promotional network, the user can select the “my network” link in a menu. A map can be displayed and a list view of those partners that have accepted a user's invitations or vice versa can be shown. On a list view, a user can also see a “promotion status” and “print status” of a user's partners. That is, whether a user's partners have set up their promotion or printed their AdSheet for a time period, such as for example for an “active month”. If a user is keeping track via the “logged redemptions” tool, a user can also see total partner redemptions on this screen.

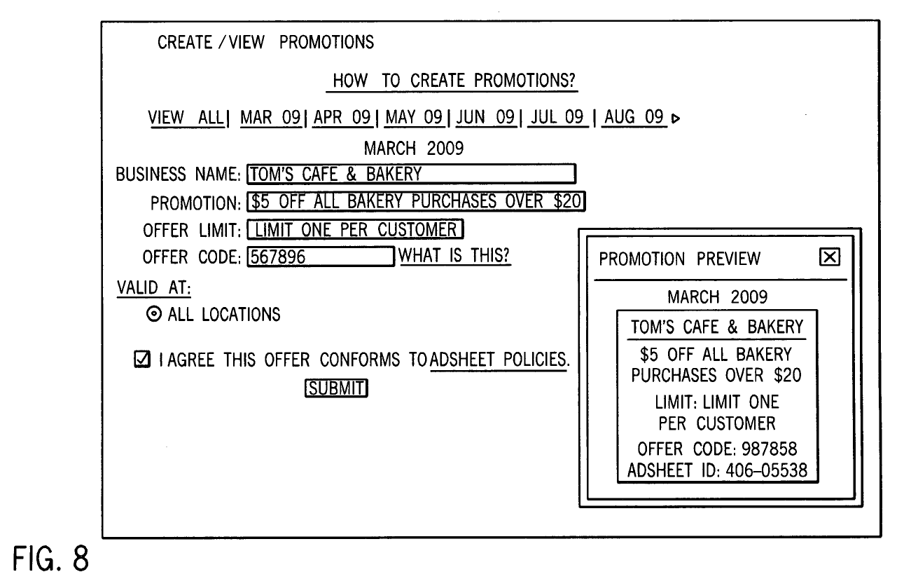

Referring to FIG. 8, creating promotions subroutine is described. The “create promotions” link in the menu is selected. A user can create a promotion for each time period such as for example each month of the year. A user can choose to set the up one time period at a time or set up the whole year.

A description of a user's promotion is entered (e.g., “Save 20% on all holiday merchandise”). An optional offer limit, if applicable, can be included (e.g., one per customer). An “offer code” is also an optional field. A user can use “offer code” if the user has a cash register that accepts a discount code or another tracking system. If a user has more than one location, a user may choose to limit the promotion to one location. Finally, a user can preview a user's promotion.

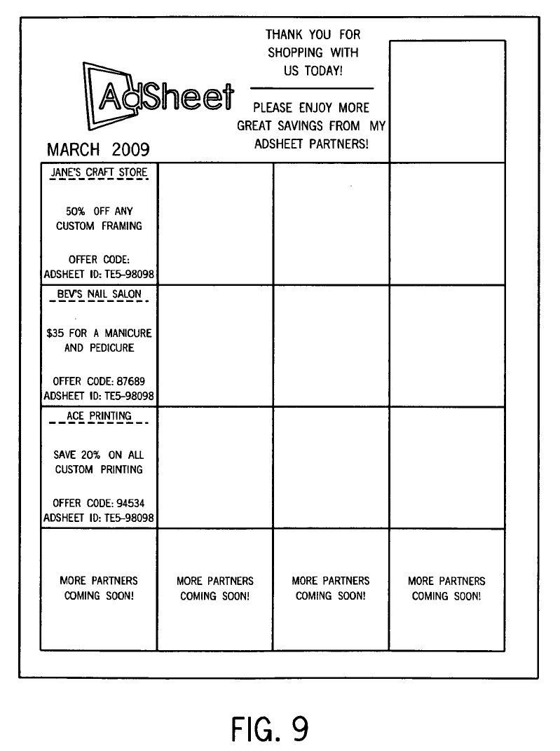

Referring to FIG. 9, printing a user's AdSheet subroutine is described. The “print AdSheet” link on the menu can be selected. Before a user's AdSheet is created, a user will have an opportunity to review if a user's partners' promotions are ready. If a user prints a user's AdSheet before a partner's promotion is ready, then that partner's promotion will not appear on a user's AdSheet. A user may choose to send them a reminder message before sprinting.

The “print” button is selected and a user's AdSheet will be automatically generated, for example as a Portable Document Format (PDF) file (a format available on most computers). The user's AdSheet can then be printed, copies made, and distributed to customers. An example of an AdSheet is seen in FIG. 9.

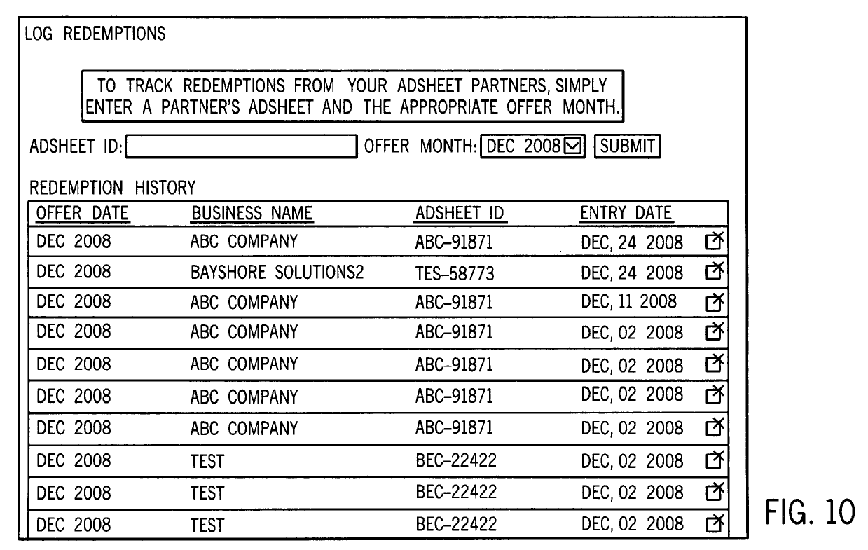

Referring to FIG. 10, printing logging redemptions subroutine is described. Coupons that customers redeem in a user's business are collected. Coupons include the unique ID of an AdSheet member. The “log redemptions” link in the menu is selected. The AdSheet ID from the coupon redeemed and the appropriate month are entered, and “submit” is selected. A user can sort redemptions by offer date, business name, ID and date. A user can view total redemptions by partner on the “my network” screen.

In an additional embodiment, an email notice reminding members to create their promotion before the next time period can be automatically generated, with another email notice telling members to print their AdSheet can be automatically generated.

While the invention has been described with specific embodiments, other alternatives, modifications, and variations will be apparent to those skilled in the art. Accordingly, it will be intended to include all such alternatives, modifications and variations set forth within the spirit and scope of the appended claims.

What is claimed is:

1. An Internet-based method for creating a business promotional network for offline businesses comprising:
a user registering for the system;
the user searching for businesses that are also members;
the user inviting members to join a user's promotional network;
the user creating a promotion; and
automatically generating a promotional material based on the user's and any user's promotional network member's promotions.

2. The Internet-based method for creating a business promotional network for offline businesses of claim 1 further comprising a user registering for the system and creating a profile for the user's business.

3. The Internet-based method for creating a business promotional network for offline businesses of claim 1 further comprising the user searching for businesses in a user's area that are also members.

4. The Internet-based method for creating a business promotional network for offline businesses of claim 3 further comprising displaying on a map businesses in a user's area that are also members.

5. The Internet-based method for creating a business promotional network for offline businesses of claim 1 further comprising the user inviting members in a defined category to join a user's promotional network.

6. The Internet-based method for creating a business promotional network for offline businesses of claim 5 further comprising the user inviting members that serve customers in the same demographic category to join a user's promotional network.

7. The Internet-based method for creating a business promotional network for offline businesses of claim 1 further comprising the user creating a promotion for a given time period.

8. The Internet-based method for creating a business promotional network for offline businesses of claim 7 further comprising the user creating a promotion for a month.

9. The Internet-based method for creating a business promotional network for offline businesses of claim 1 further comprising automatically generating a promotional sheet and printing the promotional sheet.

10. The Internet-based method for creating a business promotional network for offline businesses of claim 9 further comprising the user distributing the promotional sheet.

11. The Internet-based method for creating a business promotional network for offline businesses of claim 9 further comprising a user's promotional network member distributing the promotional sheet.

12. The Internet-based method for creating a business promotional network for offline businesses of claim 1 further comprising tracking which members are sending a user customers.

13. The Internet-based method for creating a business promotional network for offline businesses of claim 12 further comprising tracking which members are sending a user customers through an ID.

14. The Internet-based method for creating a business promotional network for offline businesses of claim 1 further comprising the user creating a promotion in the form of a coupon.

15. The Internet-based method for creating a business promotional network for offline businesses of claim 1 further comprising the user creating a promotion in the form of a sale.

16. A method for creating a business promotional network for offline businesses comprising:
a user registering for an Internet-based system;
the user searching for businesses that are also members;
the user inviting members to join a user's promotional network;
the user creating a promotion;
the Internet-based system automatically generating a promotional material; and
Internet-based system tracking which partners are sending a user customers.

17. The method for creating a business promotional network for offline businesses of claim 16 further comprising a user registering for the system and creating a profile for the user's business.

18. The method for creating a business promotional network for offline businesses of claim 16 further comprising the user searching for businesses in a user's area that are also members.

19. The method for creating a business promotional network for offline businesses of claim 16 further comprising the user inviting members in a defined category to join a user's promotional network.

20. The method for creating a business promotional network of claim 16 further comprising automatically generating a promotional material based on the user's and user's promotional network member's promotions.

21. The method for creating a business promotional network for offline businesses of claim 16 further comprising the user creating a promotion for a given time period.

22. The method for creating a business promotional network for offline businesses of claim 16 further comprising automatically generating a promotional sheet and printing the promotional sheet.

23. The method for creating a business promotional network for offline businesses of claim 16 further comprising tracking which members are sending a user customers through an ID.

24. An Internet web-site comprising:
a registration function that allows a user to register for the web-site;
a search function that allows a user to search for businesses that are also members;
a communication function that allows a user to invite members to join a user's promotional network; and
automatically generated promotional material based on a user promotion and user's promotional network member's promotions.

25. The Internet web-site of claim 24 further comprising a profile for the user's business.

26. The Internet web-site of claim 24 further comprising a search function that allows a user to search for businesses in a user's area that are also members.

27. The Internet web-site of claim 24 further comprising a communication function that allows a user to invite members in a defined category to join a user's promotional network.

28. The Internet web-site of claim 24 further comprising promotional material based on a user promotion and user's promotional network member's promotions for a given time period.

29. The Internet web-site of claim 24 further comprising an automatically generated printed promotional sheet.
